(19) United States
(12) Patent Application Publication
(10) Pub. No.: US 2007/0139345 A1
(43) Pub. Date: Jun. 21, 2007

(54) Active matrix liquid crystal display and driving method thereof for adjusting refresh rate according to frequency of ambient light

(75) Inventors: De-Ching Shie, Miao-Li (TW); Hsien-Ying Chou, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,914

(22) Filed: Dec. 21, 2006

(30) Foreign Application Priority Data
Dec. 21, 2005 (CN) 200510121043.6

(51) Int. Cl. G09G 3/36

(52) U.S. Cl. 345/98

(57) ABSTRACT

An exemplary liquid crystal display (LCD) (200) includes an LCD panel (250); a gate driving circuit (240) configured for scanning the LCD panel; a data driving circuit (230) configured for providing a plurality of gradation voltages to the LCD panel; an optical sensor (210) configured for measuring a frequency of ambient light and generating a corresponding measurement signal; a timing control circuit (220) configured for receiving the measurement signal and adjusting a refresh rate of images shown by the LCD panel according to the frequency of the ambient light.

### FIELD OF THE INVENTION

The present invention relates to an active matrix liquid crystal display (LCD) and a driving method of the active matrix LCD for adjusting a refresh rate of a display screen of the active matrix LCD according to the frequency of the ambient light.

### GENERAL BACKGROUND

An active matrix LCD device has the advantages of portability, low power consumption, and low radiation, and has been widely used in various portable information products such as notebooks, personal digital assistants (PDAs), video cameras and the like. Furthermore, the active matrix LCD device is considered by many to have the potential to completely replace CRT (cathode ray tube) monitors and televisions.

FIG. 4 is a block diagram of a typical active matrix LCD including circuits thereof. The active matrix LCD 100 includes an LCD panel 140, a data driving circuit 120, a gate driving circuit 130, and a timing control circuit 110. The timing control circuit 110 is used to control the gate driving circuit 130 and the data driving circuit 120. The gate driving circuit 130 provides a plurality of scanning signals to the LCD panel 140. The data driving circuit 120 provides a plurality of gradation voltages to the LCD panel 140 when the LCD panel 140 is scanned.

An image shown on a display screen of the active matrix LCD 100 is refreshed (i.e. replaced by a new identical image) at a predetermined frequency. In particular, the active matrix LCD 100 normally works with a predetermined refresh rate such as sixty hertz, seventy-five hertz, or another similar refresh rate. When a frequency of ambient light changes from a first frequency such as fifty-five hertz to a second frequency such as seventy-five hertz, the active matrix LCD 100 does not adjust the refresh rate thereof to adapt to the frequency of the ambient light. Thus a user may find that his or her eyes easily become tired.

What is needed, therefore, is an active matrix LCD that can overcome the above-described deficiency.

### SUMMARY

In one preferred embodiment, an active matrix LCD includes an LCD panel, a gate driving circuit configured for scanning the LCD panel, a data driving circuit configured for providing a plurality of gradation voltages to the LCD panel, an optical sensor configured for measuring a frequency of ambient light and generating a corresponding measurement signal, and a timing control circuit configured for receiving the measurement signal and adjusting a refresh rate of images shown by the LCD panel according to the frequency of the ambient light.

Other advantages and novel features will become more apparent from the following detailed description when taken in conjunction with the accompanying drawings.

### BRIEF DESCRIPTION OF THE DRAWINGS

FIG. 1 is a block diagram of an active matrix LCD according to an exemplary embodiment of the present invention, the active matrix LCD including a timing control circuit.

FIG. 2 is essentially a block diagram of circuits of the timing control circuit of FIG. 1.

FIG. 3 is a flowchart of an exemplary driving method used to adjust a refresh rate of the LCD of FIG. 1.

FIG. 4 is a block diagram of a conventional active matrix LCD including circuits thereof.

### DETAILED DESCRIPTION OF PREFERRED EMBODIMENTS

FIG. 1 is a block diagram of an active matrix LCD according to an exemplary embodiment of the present invention. The active matrix LCD 200 includes an LCD panel 250. The active matrix LCD 200 is configured such that an image shown on a display screen (not shown) of the LCD panel 250 is refreshed at a predetermined frequency. The active matrix LCD 200 also includes a data driving circuit 230, a gate driving circuit 240, a timing control circuit 220, and an optical sensor 210 positioned on the LCD panel 250. The timing control circuit 220 is used to control the gate driving circuit 240 and the data driving circuit 230. The gate driving circuit 240 provides a plurality of scanning signals to the LCD panel 250. The data driving circuit 230 provides a plurality of gradation voltages to the LCD panel 250 when the LCD panel 250 is scanned. The optical sensor 210 is configured for measuring a frequency of ambient light and providing a measurement signal representing the frequency of the ambient light to the timing control circuit 220. Thus the timing control circuit 220 adjusts the refresh rate of the LCD panel 250 according to the measurement signal.

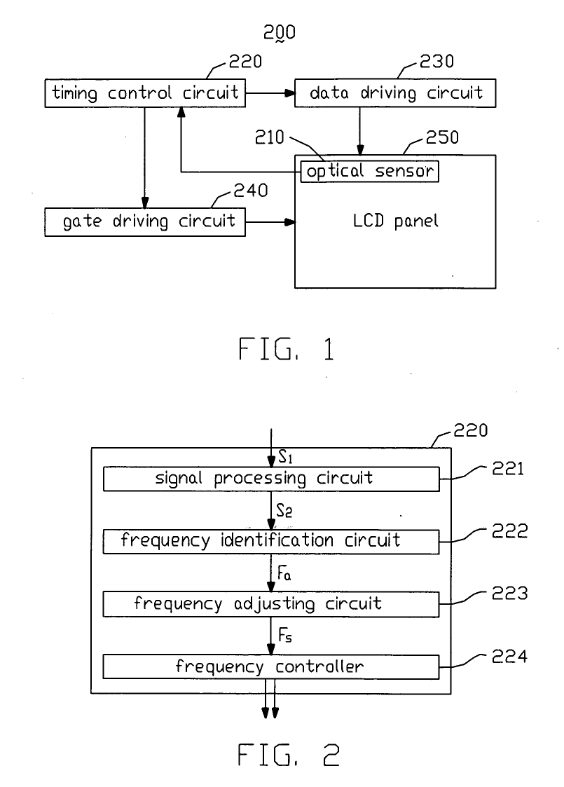

FIG. 2 is essentially a block diagram of circuits of the timing control circuit 220. The timing control circuit 220 includes a signal processing circuit 221, a frequency identification circuit 222, a frequency adjusting circuit 223, and a frequency controller 224 connected in series. The signal processing circuit 221 is connected to the optical sensor 210. The frequency controller 224 is connected to the gate driving circuit 240 and the data driving circuit 230.

The signal processing circuit 221 receives the measurement signal S1 from the optical sensor 210, and transforms the measurement signal S1 into a main frequency signal S2 that can be recognized by the frequency identification circuit 222. The frequency identification circuit 222 recognizes the frequency Fₐ of the main frequency signal S2, and provides the frequency Fₐ to the frequency adjusting circuit 223. The frequency adjusting circuit 223 transforms the frequency Fₐ to a refresh rate Fₛ of the LCD panel 250, and provides two control signals to the gate driving circuit 240 and the data driving circuit 230 respectively according to the refresh rate Fₛ. For example, when the frequency of the ambient light is fifty hertz, the refresh rate can be set to sixty-seven hertz. That is, the refresh rate can be a selected refresh rate that generally corresponds to the frequency of the ambient light. Further, the refresh rate corresponding to a particular frequency of the ambient light can be determined in advance by a manufacturer of the active matrix LCD 200 or by a user.

In an alternative embodiment of the present invention, a single optical sensor or a plurality of optical sensors can be used to measure the frequency of the ambient light. The optical sensor(s) can be positioned in the LCD panel 250 or on a surface of the LCD panel 250.

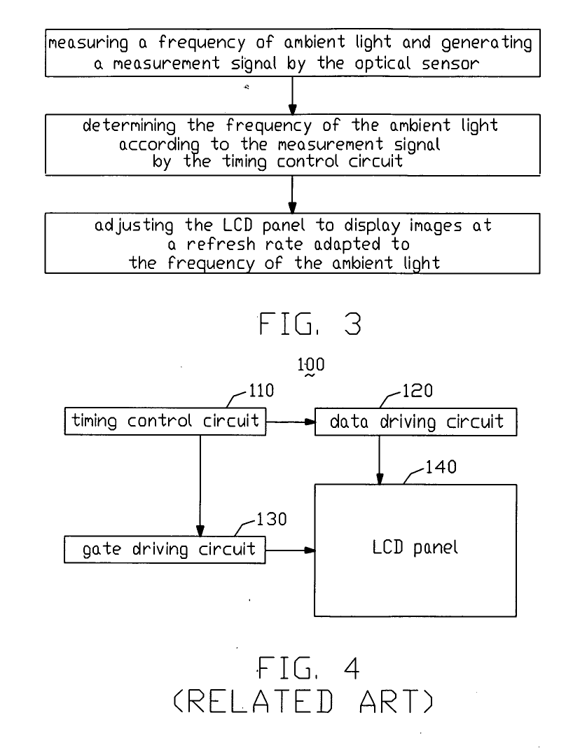

FIG. 3 is a driving method used to adjust the refresh rate of the active matrix LCD 200. The driving method includes: measuring a frequency of ambient light and generating a measurement signal, by the optical sensor 210; determining the frequency of the ambient light according to the measurement signal, by the timing control circuit 220; and adjusting the LCD panel 250 to display images at a refresh rate adapted to the frequency of the ambient light.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An active matrix liquid crystal display (LCD), comprising:
an LCD panel;
a gate driving circuit configured for scanning the LCD panel;
a data driving circuit configured for providing a plurality of gradation voltages to the LCD panel;
an optical sensor configured for measuring a frequency of ambient light and generating a corresponding measurement signal; and
a timing control circuit configured for receiving the measurement signal and adjusting a refresh rate of images shown by the LCD panel according to the frequency of the ambient light.

2. The active matrix LCD as claimed in claim 1, wherein the timing control circuit comprises a signal processing circuit, a frequency identification circuit, a frequency adjusting circuit, and a frequency controller connected in series, the signal processing circuit being connected to the optical sensor, the frequency adjusting circuit being connected to both the gate driving circuit and the data driving circuit.

3. The active matrix LCD as claimed in claim 2, wherein the signal processing circuit receives the measurement signal from the optical sensor, and transforms the measurement signal into a main frequency signal.

4. The active matrix LCD as claimed in claim 2, wherein the frequency controller provides control signals to the gate driving circuit and the data driving circuit according to the frequency of ambient light.

5. The active matrix LCD as claimed in claim 2, wherein the optical sensor is positioned on the LCD panel.

6. A driving method for an active matrix liquid crystal display (LCD), the active matrix LCD comprising an LCD panel, an optical sensor positioned with the LCD panel, and a timing control circuit, the driving method comprising:
measuring a frequency of the ambient light using the optical sensor, and generating a corresponding measurement signal;
determining the frequency of the ambient light according to the measurement signal, by the timing control circuit; and
adjusting the LCD panel to display images at a refresh rate selectably corresponding to the frequency of the ambient light.

7. The driving method as claimed in claim 6, further comprising:
transforming the measurement signal into a main frequency signal:
recognizing a frequency of the main frequency signal; and
transforming the recognized frequency to the refresh rate corresponding to the frequency of the ambient light.

8. The driving method as claimed in claim 7, wherein the refresh rate is set to be sixty-seven hertz when the frequency of the ambient light is fifty hertz.

9. The driving method as claimed in claim 6, wherein the refresh rate selectably corresponding to the frequency of the ambient light is predetermined.
